(19) United States
(12) Patent Application Publication
(10) Pub. No.: US 2006/0271342 A1
(43) Pub. Date: Nov. 30, 2006

(54) Cort_x: a dynamic brain model

(75) Inventors: Nabil H. Farhat, Philadelphia, PA (US); Jie Yuan, Philadelphia, PA (US); Emilio Del Moral Hernandez, Sao Paulo (BR); Geehyuk Lee, Daejeon (KR)

Correspondence Address: RATNERPRESTIA, P O BOX 980, VALLEY FORGE, PA, 19482-0980, US

(73) Assignee: Trustees of the University of Pennsylvania

(21) Appl. No.: 11/139,907

(22) Filed: May 27, 2005

(51) Int. Cl. G06F 17/10; G06F 15/18

(52) U.S. Cl. 703/2; 706/20

(57) ABSTRACT

A cortical column emulation circuit includes a capacitor which is coupled at a first end to a source of reference potential by a switch, a current source coupled to the first end of the capacitor for charging the capacitor when the switch is open to develop a capacitor voltage between the first end and the second end of the capacitor; and a comparator which compares the voltage across the capacitor to a threshold potential and generates a pulse signal when the capacitor voltage is greater than the threshold voltage. The pulse signal closes the switch to connect the first end of the capacitor to the source of reference potential. A set of cortical column emulation circuits may be coupled together by an adaptive coupling to form a cortical region emulation circuit. The adaptive coupling circuit weights an input stimulus and a plurality of state vector elements by variable coupling coefficients.

### FIELD OF THE INVENTION

The present invention relates to the field of modeling brain activity for use in data processing applications and more particularly to an implementation of a dynamical brain model of the cerebral cortex. In particular, an apparatus implementing a dynamical brain model of the cerebral cortex is disclosed for use in various data processing applications.

### BACKGROUND OF THE INVENTION

Corticonics, echoing electronics, is the art of identifying anatomical and physiological attributes of cortical organization to be abstracted and used in the modeling and simulation of the cortex. Generally, the cortex, in conjunction with the subcortical centers, is responsible for higher-level brain functions such as cognition, thought, language, memory and learning, control of the complex motor function, and possibly the more esoteric attributes of intention, awareness and consciousness. In fact, about 75% of all human brain tissue, defining the association cortices is devoted to these functions. Thereby, understanding the workings of the cortex can have profound scientific, technological, and clinical implications. Unfortunately, the intrinsic interest of these higher-level functions is equaled by the difficulties involved—both technical and conceptual—in understanding their neurobiological basis. Nonetheless, progress to further this incomplete understanding is being made through studies of brain tissue that is damaged or has lesions, from in vivo imaging of the brain, and from electrode and patch-clamp studies in non-human primates. These studies aim at developing a complementary computational approach to modeling and studying the cortex employing the concepts and tools of nonlinear dynamics and information theory.

The non-linearity and organization of cortical tissue make the cortex a high-dimensional non-linear dynamical system. As such, it exhibits in its state-space not only static (fixed point) attractors but also dynamic (periodic, quasi-periodic and strange or chaotic) attractors depending on its location in parameter space. Important questions, however, remain unanswered about these brain functions and, specifically, about the role of attractors in cortical cognitive processes. An assumption is that the most obvious role for attractors is to make it possible to operate on or utilize the activity trace caused by a stimulus after the stimulus has disappeared. Several important inquiries result from this assumption. Namely, 1) Is a particular attractor associated with the recognition of a particular object or stimulus?; 2) Is the settling of cortical activity onto an attractor state synonymous with the recognition process?; and 3) Is such persistent activity needed for the formation of memory?

Current modeling practices fall short of providing answers to these inquiries. Neural networks are the predominate model used to explain brain functions and how these brain functions could be modeled in computing environments. Specifically, a neural network is an information processing paradigm that is inspired by the way biological nervous systems process information. The key element of this paradigm is the novel structure of the information processing system. It is generally composed of a large number of highly interconnected processing elements (neurons) working collectively to solve specific problems. Neural networks have an ability to derive meaning from complicated or imprecise data. This ability can be used to extract patterns and detect trends that are too complex to be noticed by either humans or other computer techniques.

Current brain computational models, however, do not effectively predict the behavior observed in the cortex. More specifically, current models do not effectively choose those features of cortical organization to make salient in the model and eliminate and ignore those features of cortical organization that do not provide any added benefit. The test of the model lies in how well it can produce, predict, and synthesize cortical functions. Current models, although effective in providing a general model for brain and/or nervous system functions do not effectively and reliably model detailed cortical functions—functions that, if properly modeled, could provide substantial insight into higher-level brain function and into how to process large volumes of data. Such insight may be applied to numerous data intensive processing applications to extract meaning and improve processing efficiencies. With increased processing efficiencies computing technologies could be used to automate numerous tasks that we take for granted, such as voice recognition and synthesis, data searching, basic learning, etc.

It is often seen that a one-dimensional (“1-D”) map arises as a simple model for explaining the dynamics of complex physical or biological systems, such as an ecological system, periodically driven nonlinear oscillators, condensed-matter systems, chemical reaction systems, and laser systems. 1-D maps occur also in the modeling of a neuron or an assembly of neurons. All of these suggest the potential of a 1-D map as an information processing element. Indeed, there are already many successful applications of a 1-D map in information processing systems. A few examples are artificial neural networks for combinatorial optimization, image processing systems for object segmentation, communication systems using a map to generate chaotic carriers, and communication systems utilizing the synchronizing behavior of the coupled map lattice.

In spite of the increasing application possibilities of 1-D maps, relatively little effort has been made in search for an efficient hardware design to compute a 1-D map. One may argue that there is no point in designing any dedicated hardware since a digital computer can compute a 1-D map efficiently due to the map's mathematical simplicity. In fact, this is true only in part: there are many good reasons why a dedicated hardware design to compute a 1-D map would be desirable. First, there are occasions where parallel or collective processing in multiple 1-D maps needs to be considered. An obvious example is a network of 1-D maps. Although collective computations carried out by such a network can be simulated on a digital computer, this approach may often be too slow for certain applications, e.g. where the number of maps in the network and the number of interconnections among these maps is large. Second, some applications require a compact and low-power solution to computing 1-D maps. A typical example is a secure communication system utilizing the chaotic signal of a 1-D map.

The search for a hardware design to compute 1-D maps has involved the effort to implement a neural network consisting of 1-D maps. This body of work has involved a simple model of a biological neuron, called a bifurcating neuron (“BN”), driven by an external sinusoidal signal. The bifurcating neuron is so-named because the original work on the BN revealed that it could, when driven by an external sinusoidal signal, exhibit complex bifurcating behavior that resembles the experimental observations of real biological neurons. A detailed description by Emilio Del Moral Hernandez, Geehyuk Lee, and Nabil H. Farhat of the mathematical definition of a bifurcating neuron and how to choose the external driving signal that controls which 1-D map the BN computes can be found in “Analog Realization of Arbitrary One-Dimensional Maps,” IEEE Transaction on Circuits and Systems I: Fundamental Theory and Applications, Vol. 50, No. 12, (December 2003).

Despite the BN's rich dynamical properties, its mathematical definition is simple enough to lend itself to a compact circuit implementation. As an example of a possible circuit model of the BN, previous work has described the programmable unijunction transistor oscillator neuron (“PUTON”), which is a simple circuit built around a programmable unijunction transistor (“PUT”). The Moral article, above, describes an implementation of a PUTON. Notably, it has been shown that the firing time of the BN with respect to the phase of the external sinusoidal signal may be precisely determined by the sine-circle map. Conversely, this means that the BN is computing the sine-circle map. Physical limitations of present PUTs, however, render effective implementations of the BN impossible.

From the foregoing it is appreciated that there exists a need for a hardware implementation of a BN as part of a dynamical brain model, and specifically the cortex, that may be applied to various data processing applications.

### SUMMARY OF THE INVENTION

In an exemplary embodiment of the present invention, a cortical column emulation circuit is provided. A cortical column emulation circuit includes the following: a capacitor having a first end and a second end which is coupled to a source of reference potential; a switch configured to close responsive to a control signal for selectively coupling the first end of the capacitor to a source of reference signal; a current source coupled to the first end of the capacitor for charging the capacitor when the switch is open to develop a capacitor voltage between the first end and the second end of the capacitor; and a comparator coupled to the first end of the capacitor and to a threshold voltage. The comparator is configured to generate an output signal at an output terminal of the comparator. The output signal of the comparator includes a first comparator state signal value that corresponds to a first relationship between the capacitor voltage and the threshold voltage and a second comparator state signal value that corresponds to a second relationship between the capacitor voltage and the threshold voltage. The cortical column emulation circuit further includes a pulse generator coupled to the output terminal of the comparator. The pulse generator generates a pulse signal when the output signal of the comparator transitions from the first comparator state signal value to the second comparator state signal value. The pulse signal is also the control signal for the switch. A set of cortical column emulation circuits may be coupled together to form a cortical region emulation circuit.

In another exemplary embodiment of the present invention, an adaptation circuit is provided. The adaptation circuit includes a logarithm circuit and a multiplication circuit coupled to the logarithm circuit. The logarithm circuit, which receives the first input signal, computes a logarithm of the first input signal. The multiplication circuit receives a second input signal and the logarithm of the first input signal and multiplies the logarithm of the first input signal by the second input signal to generate an internal signal. The adaptation circuit further includes an exponentiation circuit coupled to the multiplication circuit. The exponentiation circuit receives the internal signal and computes an exponent of the internal signal to generate an output signal.

In another exemplary embodiment of the present invention, a processing element is provided. The processing element includes a local sensory element of a sensory input vector, a local state element of a state vector, a plurality of coupling factors, a rest potential waveform, and a coupler circuit for coupling the processing element to a plurality of external processing elements. The coupler circuit computes a bifurcation parameter Uᵢ responsive to the local sensory element, the state vector, and the plurality of coupling factors. The processing element further includes a cortical column emulation circuit that modifies the local state element responsive to the bifurcation parameter Uᵢ and the rest potential signal. The cortical column emulation circuit models a bifurcating neuron that computes a one-dimensional map determined by the rest potential signal.

In yet another exemplary embodiment, a cortical region emulation circuit is provided. The cortical region emulation circuit includes a sensory input vector, a state vector, and a set of processing elements for calculating the state vector. Each processing element in the set of processing elements is coupled to a subset of processing elements of the set of processing elements and modifies an element of the state vector responsive to: 1) a respective element of the sensory input vector modified by a vector of sensory coupling factors, 2) a plurality of respective elements of the state vector modified by a vector of state coupling factors, 3) a rest potential signal, and 4) a respective element of a vector of bifurcation parameters.

### BRIEF DESCRIPTION OF THE DRAWINGS

FIG. 1A is a generalized circuit diagram for an integrated relaxation oscillator neuron (“IRON”) in accordance with the present invention.

FIG. 1B is the generalized circuit diagram of FIG. 1A with additional circuitry for generating a relaxation potential and a series of output values.

FIG. 2A is a schematic diagram of an IRON in accordance with the present invention.

FIG. 2B is an output plot of various voltages at specific points of the IRON of FIG. 2A.

FIG. 2C is a plot of three driving functions which may be applied to a bifurcating neuron (“BN”) to cause the BN to compute a sine-circle map.

FIG. 2D is a plot of three driving functions which may be applied to a BN to cause the BN to compute a logistic map.

FIG. 2E is a plot of three driving functions which may be applied to a BN to cause the BN to compute a tent map.

FIG. 3A is a diagram of an actual output of an IRON computing a sine-circle map.

FIG. 3B is a diagram of a numerical computation of a sine-circle map.

FIG. 4A is a diagram of an actual output of an IRON computing a logistic map.

FIG. 4B is a diagram of a numerical computation of a logistic map.

FIG. 5A is a diagram of an actual output of an IRON computing a tent map.

FIG. 5B is a diagram of a numerical computation of a tent map.

FIG. 6 is a block diagram of a local processing element which contains a cortical column emulation circuit and a coupler circuit and which is coupled to two external processing elements.

FIG. 7 is a block diagram of a local processing element which contains a cortical column emulation circuit and a coupler circuit and which is coupled to N external processing elements.

FIG. 8 is a block diagram of an adaptation circuit included in a coupler circuit.

FIG. 9 is a circuit diagram of an analog multiplier circuit included in the adaptation circuit of FIG. 8.

FIG. 10 is a circuit diagram of a logarithmic circuit included in the adaptation circuit of FIG. 8.

FIG. 11 is a circuit diagram of an exponential circuit included in the adaptation circuit of FIG. 8.

FIG. 12 is a plot of the output of the adaptation circuit of FIG. 8 and a plot of the theoretical output of the function computed by the adaptation circuit.

FIG. 13 is a circuit diagram for a cortical region emulation circuit which emulates a cortical region of the cerebral cortex in accordance with the present invention.

### DETAILED DESCRIPTION OF THE INVENTION

The present invention relates to a circuit and various subcircuits which model a cortical region of the brain. More specifically, the present invention relates to a network of emulated bifurcating neurons (“BN”), which network models a cortical region of the brain. The network adapts temporally according to a sensory input vector, a state vector, and internal coupling factors. An embodiment of the present invention is a plurality of integrated-circuit relaxation oscillator neurons (“IRONs”) networked together to form a cortical region emulation circuit. The IRON, when driven by certain periodic waveforms, exhibits many of the characteristics of a BN.

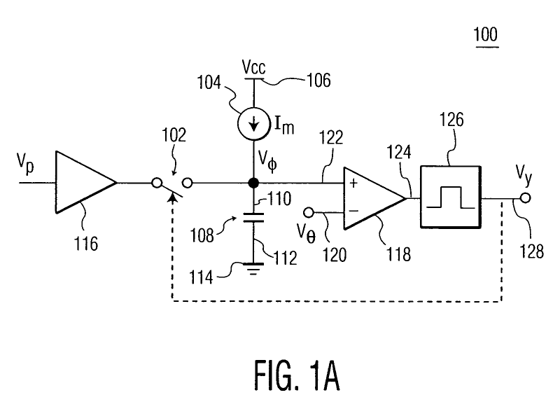

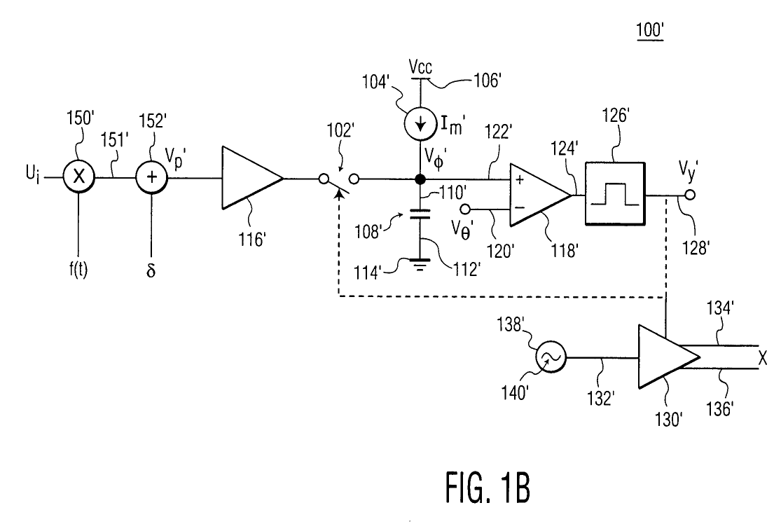

FIG. 1A depicts an IRON 100, an exemplary embodiment of a cortical column emulation circuit of the present invention. IRON 100 is shown in simplified form, omitting details of several of the commonly-understood underlying circuits.

First, the topology and persistent operation of IRON 100 is described. A source of reference signal, relaxation potential V_{ρ}, is applied to voltage follower 116. Relaxation potential V_{ρ} is coupled to switch 102 by voltage follower 116 which isolates relaxation potential V_{ρ} from loading by the rest of the circuit. The waveform of relaxation potential V_{ρ} controls the behavior of IRON 100. More specifically, the waveform of relaxation potential V_{ρ} controls whether IRON 100 computes a sine-circle map, a logistic map, a tent map, etc. Thus, relaxation potential V_{ρ} drives the behavior of IRON 100 and in an exemplary embodiment is a driving function of IRON 100. It should be appreciated by one skilled in the art that such behavior is also exhibited by a BN.

Capacitor 108 consists of two ends: second end 112 which is coupled to source of reference potential 114 and first end 110 which is coupled to input terminal 122 of comparator 118. In an exemplary embodiment reference potential 114 is ground potential. Capacitor voltage V_{φ} is the voltage at first end 110. Switch 102 selectively couples voltage follower 116 to first end 110 of capacitor 108 responsive to a control signal.

Current source 104, which produces current Iₘ, is coupled at one end to source of operating potential 106, which in an exemplary embodiment is V_{CC}. The other end of current source 104 is coupled to first end 110 of capacitor 108.

Input terminal 122 of comparator 118 is coupled to first end 110 of capacitor 108, thereby applying the capacitor voltage V_{φ} to input terminal 122 of comparator 118. Input terminal 120 of comparator 118 is coupled to a source of threshold voltage V_{θ}. Comparator 118 generates an output signal at output terminal 124 which is coupled to pulse generator 126. Pulse generator 126 generates a pulse signal at output terminal 128. In an exemplary embodiment, pulse generator 126 is a monostable multivibrator. Output terminal 128 of pulse generator 126 is coupled to switch 102 to control the opening and closing of switch 102.

Next, the transitory operation of IRON 100 is described. At the beginning of a cycle, switch 102 has just opened and capacitor voltage V_{φ} is less than or equal to threshold voltage V_{θ}, creating a first relationship between capacitor voltage V_{φ} and threshold voltage V_{θ}. Because the first relationship holds true between capacitor voltage V_{φ} and threshold voltage V_{θ}, comparator 118 generates a first comparator state signal value, e.g. logic-low, at output terminal 124. At this time, switch 102 is open which allows current Iₘ from current source 104 to charge capacitor 108. As current Iₘ flows into capacitor 108, capacitor voltage V_{φ} increases to a level greater than threshold voltage V_{θ}, creating a second relationship between capacitor voltage V_{φ} and threshold voltage V_{θ}. As soon as capacitor voltage V_{φ} exceeds threshold voltage V_{θ}, comparator 118 ceases generating the first comparator state signal value at output terminal 124 and begins generating a second comparator state signal value, e.g. logic-high, at output terminal 124.

The input terminal of pulse generator 126 is coupled to output terminal 124 of comparator 118. The transition of the first comparator state signal value to the second comparator state signal value at output terminal 124 causes pulse generator 126 to generate a pulse signal V_{y} at output terminal 128 which is coupled to switch 102. Pulse signal V_{y} is the control signal for switch 102 and controls the opening and closing of switch 102. When switch 102 receives pulse signal V_{y}, switch 102 closes which causes capacitor 108 to discharge. Switch 102 remains closed for a sufficient time (determined by the time-constant of pulse generator 126) such that capacitor voltage V_{φ} reaches the instantaneous value of relaxation potential V_{ρ} after which switch 102 opens.

The recovery time of capacitor voltage V_{φ} is constant as long as the pulse width of pulse signal V_{y} is substantially constant. Since the pulse width of pulse signal V_{y} depends on the internal characteristics of pulse generator 126, the pulse width of pulse signal V_{y} is not truly constant from pulse to pulse. The problem of constant recovery time, however, is isolated from the threshold dynamics and is in a manageable form. A well-designed pulse generator can keep the variability of the pulse width within 1%, if it is operating in reasonable environmental conditions.

FIG. 1B shows an IRON 100′, an exemplary embodiment of a cortical column emulation circuit. IRON 100′ is shown in simplified form, omitting details of several of the commonly-understood underlying circuits. IRON 100′ contains all of the respective circuit elements of IRON 100 described in reference to FIG. 1A and contains additional circuitry for generating relaxation potential V_{ρ}′ and for generating output values. For purposes of the description of IRON 100′, the description of IRON 100 is incorporated.

First, the generation of relaxation potential V_{ρ}′ is described. Multiplier 150′ receives, at its two input terminals, bifurcation parameter Uᵢ and rest potential signal f(t) and multiplies together bifurcation parameter Uᵢ and rest potential signal f(t) to generate signal 151′. Adder 152′ receives, at its two inputs terminals, signal 151′ and an offset voltage δ and adds together signal 151′ and the offset voltage δ to generate relaxation potential V_{ρ}′ which is applied to voltage follower 116′. Offset voltage δ compensates for non-ideal operation of the circuit. It is contemplated, however, that IRON 100′ may be implemented without offset voltage δ or adder 152′.

Next, the circuitry for computing the sequence of output values is described. Output terminal 128′ of pulse generator 126′ is coupled to sample-and-hold circuit 130′. As described below, at input terminal 132′, sample-and-hold circuit 130′ samples a periodic timing signal 140′ generated by source of timing signal 138′ to produce a sequence of output values. Sampling of timing signal 140′ is performed at instants controlled by the pulse signal. Differential outputs 134′ and 136′ of sample-and-hold circuit 130′ form X, which is an element of a state vector \vec{X} of IRON 100′. Because X changes over time, the changing values of X generate the sequence of output values.

IRON 100′ also exhibits the transitory behavior of IRON 100 disclosed in FIG. 1A. Now, the transitory behavior unique to IRON 100′ is described. Output terminal 128′ of pulse generator 126′ is coupled to sample-and-hold circuit 130′. When sample-and-hold circuit 130′ receives pulse signal V_{y}′, sample-and-hold circuit 130′ samples a value of timing signal 140′ to generate output value X. In order for sample-and-hold circuit 130′ to capture information sufficient to compute a 1-D map, the period of timing signal 140′ is desirably at least as long as the time required to charge capacitor 110′ from the lowest instantaneous value of relaxation potential V_{ρ}′ to threshold voltage V_{θ}′. In an exemplary embodiment, timing signal 140′ is a ramp signal. It is contemplated, however, that other monotonically varying waveforms may be used.

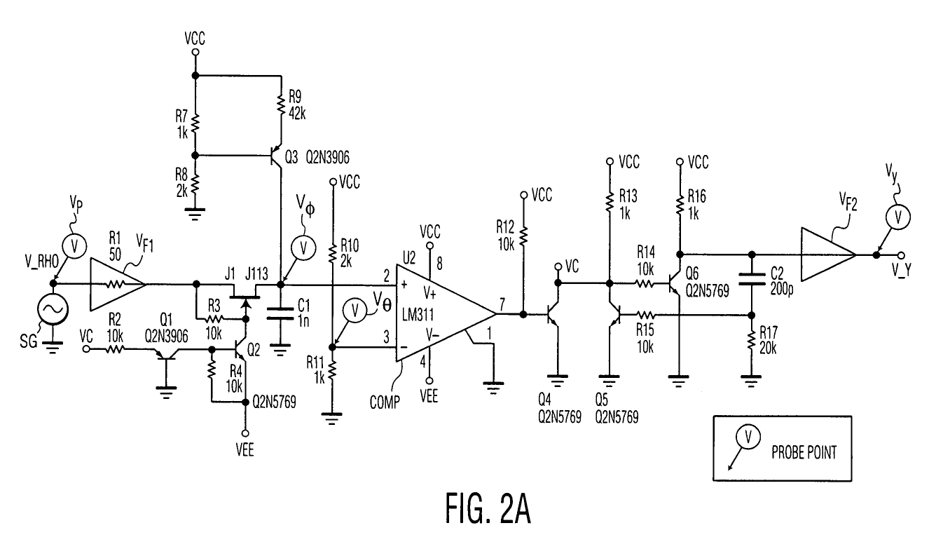

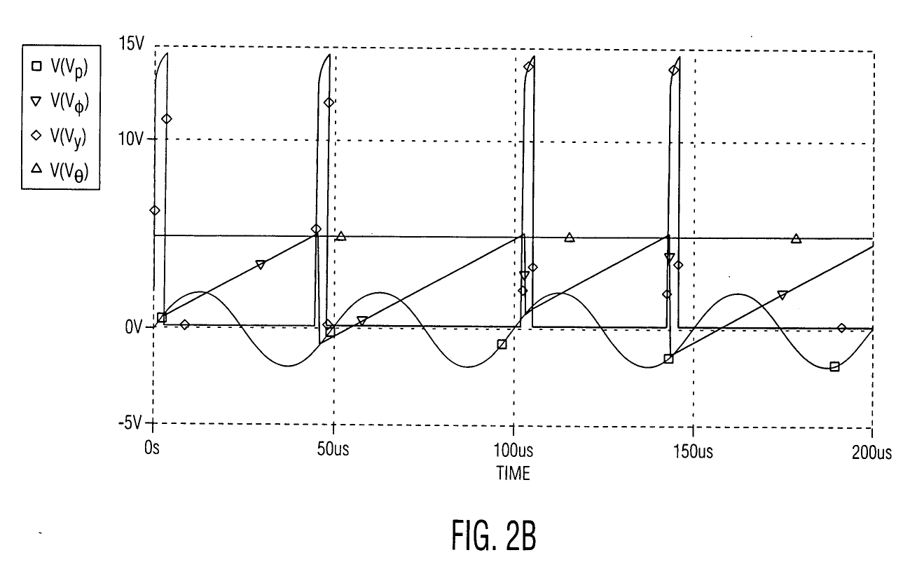

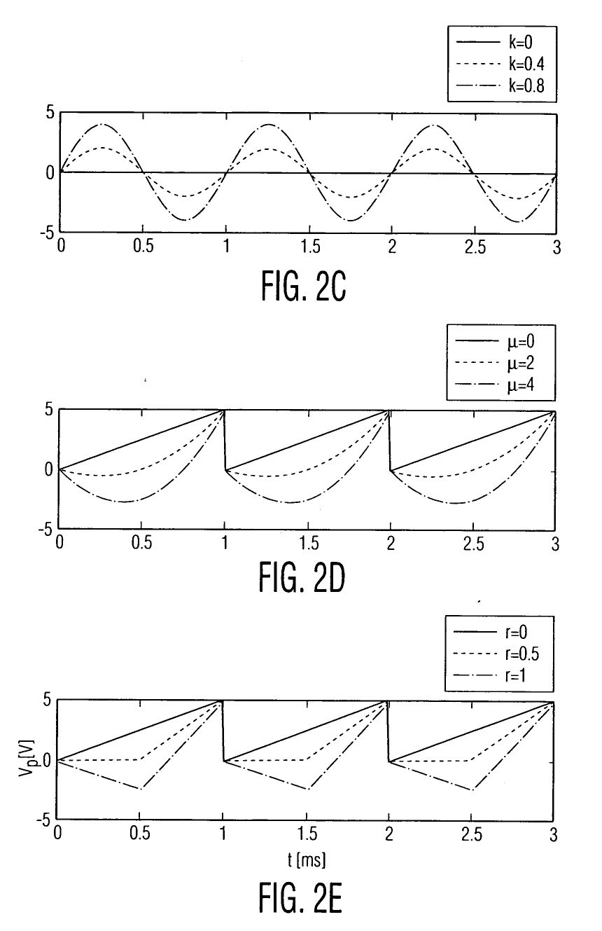

FIG. 2A shows an exemplary schematic diagram of the IRON of FIG. 1A. The two amplifiers, V_{F1} and V_{F2}, represent voltage followers. Connected to capacitor C1 is a JFET switch J1, an analog comparator COMP, and a current source using a bipolar transistor Q3. JFET switch J1 controls the path from input buffer V_{F1} to capacitor C1. Resistor R9 can be trimmed to control the constant current flowing into capacitor C1. Transistors Q1 and Q2 are added simply to shift the voltage level of the control signal VC, which is derived from the collectors of Q4 and Q5, to a level suitable to control JFET switch J1.

The part of the schematic diagram to the right of comparator COMP corresponds to the monostable multivibrator. The two symmetrically located transistors Q4 and Q5 form a NAND gate, and the third transistor Q6 acts as an inverter. The output signal of the inverter at the collector of transistor Q6 is fed back to the input terminal of the NAND gate at the base of transistor Q5 via a capacitor coupling C2. The net result is that the pulses generated by the monostable multivibrator at V_{y} have a substantially constant width whenever the output signal of comparator COMP goes high. Because the collector of transistor Q4 is coupled to the collector of transistor Q5, control signal VC is also a pulse signal.

FIG. 2B is a plot of voltages at various points of the schematic diagram of FIG. 2A. The plot includes curves of four voltages which are labeled in FIG. 2A: V_{ρ}, V_{y}, V_{φ}, and V_{θ}. V_{ρ} is the relaxation potential or driving function derived from signal generator SG in FIG. 2A and is the input voltage into voltage follower V_{F1}. V_{y} is the pulse signal of the circuit shown of FIG. 2A and is derived from the output terminal of voltage follower V_{F2}. V_{φ} is the voltage across C1, and V_{θ} is the voltage across resistor R11. The plot of V_{φ} shows the recovery time of V_{φ}, which is the time for V_{φ} to settle from a voltage equal to the threshold voltage V_{θ} to a voltage equal to the instantaneous voltage of V_{ρ}. Note that the pulse width of V_{y} is constant and longer than the recovery time of V_{φ}.

The IRON depicted in FIGS. 1A, 1B, and 2A can be used to obtain the bifurcation diagrams of 1-D maps. Three common maps include the following: the sine-circle map, the logistic map, and the tent map.

The sine-circle map can be summarized by equation (1):

$${x}_{n + 1} = f ( {x}_{n} ) ≡ {x}_{n} + Ω + \frac{K}{2 π} sin 2 π {x}_{n} \qquad ( 1 )$$

where Ω and K are positive parameters, either of which can serve as a bifurcation parameter. A BN and an IRON that models a BN compute the sine-circle map described in equation (1) when driven by a driving function or relaxation potential V_{ρ} described by equation (2):

$${V}_{ρ} ( t ) = \{ \begin{matrix}- Ω - \frac{K}{2 π} sin \frac{2 π t}{T} , & 0 \leq t < T \\ {V}_{ρ} ( t - T ) & otherwise\end{matrix} \qquad ( 2 )$$

Note that V_{ρ}(t) is periodic with period T.

The logistic map can be summarized by equation (3):
xₙ₊₁=ƒ(xₙ)≡μxₙ(1−xₙ) (3)
where the bifurcation parameter μ ranges from 0 to 4. A BN and an IRON that models a BN compute the logistic map described in equation (3) when driven by a driving function or relaxation potential V_{ρ} described by equation (4):

$${V}_{ρ} ( t ) = \{ \begin{matrix}\frac{t}{T} - μ \frac{t}{T} ( 1 - \frac{t}{T} ) , & 0 \leq t < T \\ {V}_{ρ} ( t - T ) & otherwise\end{matrix} \qquad ( 4 )$$

Note that V_{ρ}(t) is periodic with period T.

The tent map can be summarized by equation (5):

$${x}_{n + 1} = f ( {x}_{n} ) ≡ r ( 1 - 2 \vert \frac{1}{2} - {x}_{n} \vert ) \qquad ( 5 )$$

where the bifurcation parameter r ranges from 0 to 1. A BN and an IRON that models a BN compute the tent map described in equation (5) when driven by a driving function or relaxation potential V_{ρ} described by equation (6):

$${V}_{ρ} ( t ) = \{ \begin{matrix}\frac{t}{T} - r ( 1 - 2 \vert \frac{1}{2} - \frac{t}{T} \vert ) , & 0 \leq t < T \\ {V}_{ρ} ( t - T ) & otherwise\end{matrix} \qquad ( 6 )$$

Note that V_{ρ}(t) is periodic with period T.

The driving functions given by equations 2, 4, and 6 are plotted in FIGS. 2C to 2E. The driving functions in these plots represent various relaxation potentials that could be generated by signal generator SG in the IRON circuit of FIG. 2A.

FIG. 2C is a plot of the driving function for the sine-circle map, for three values of K: K=0, K=0.4, and K=0.8. FIG. 2D is a plot of the driving function for the logistic map, for three values of bifurcation parameter μ: μ=0, μ=2, and μ=4. FIG. 2E is a (t) plot of the driving function for the tent map, for three values of bifurcation parameter r: r=0, r=0.5, r=1.

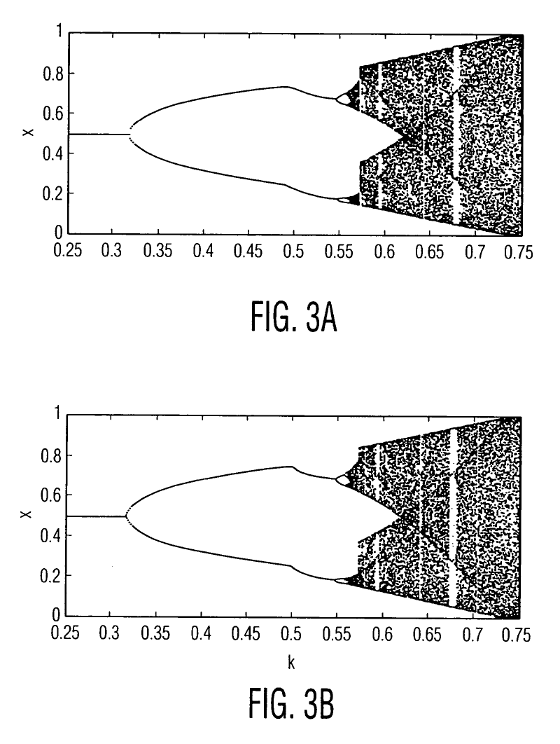

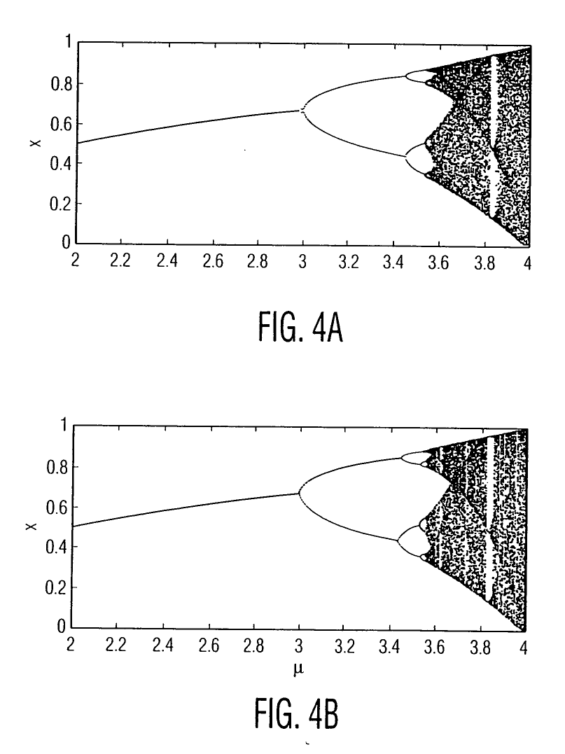

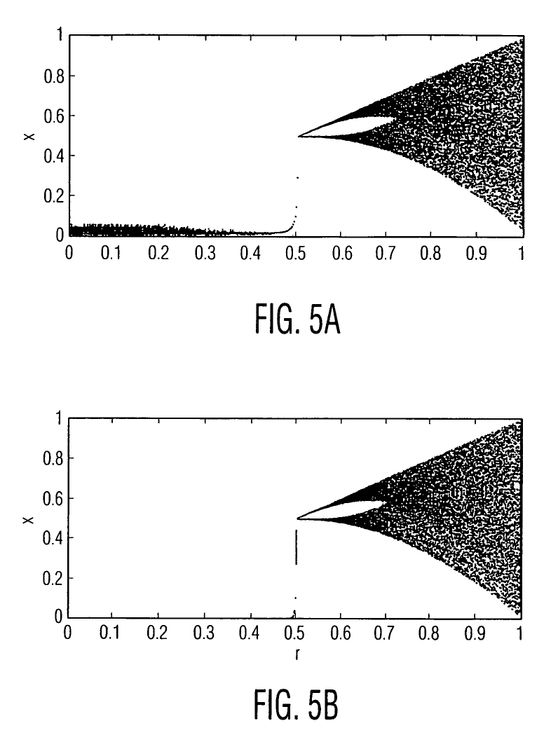

FIGS. 3A to 5B show the bifurcation diagrams of the three previously mentioned 1-D maps described by equations (1), (3), and (5). In each group of figures, an exact bifurcation diagram generated numerically for a map is shown together with the one generated by an IRON in accordance with the present invention with the same parameters. FIG. 3A is a plot of the actual measurement of the output of the IRON of FIG. 1A computing the sine-circle map. FIG. 3B is a plot of the numerical computation of the sine-circle map described by equation (2). FIG. 4A is a plot of the actual measurement of the output of the IRON of FIG. 1A computing the logistic map. FIG. 4B is a plot of the numerical computation of the logistic map described by equation (4). FIG. 5A is a plot of the actual measurement of the output of the IRON of FIG. 1A computing the tent map. FIG. 5B is a plot of the numerical computation of the tent map described by equation (6). As can been seen in these figures, the exemplary IRON circuit models these mappings very well.

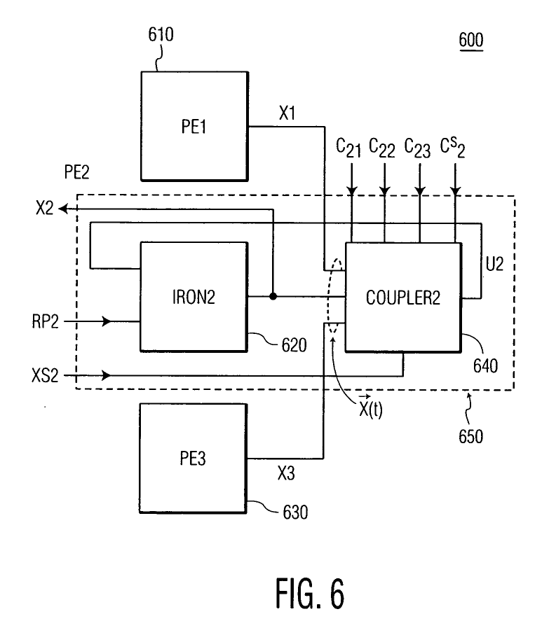

A cortical region is formed from multiple interconnected cortical columns. A circuit that interconnects several IRON circuits forms a cortical region emulation circuit. An exemplary embodiment of a cortical region emulation circuit 600 is shown in FIG. 6. Cortical region emulation circuit 600 depicts a local processing element PE2 650 connected to two external processing elements PE1 610 and PE3 630.

In an exemplary embodiment of a cortical region emulation circuit, each of the PE1 610, PE2 650, and PE3 630 of cortical region emulation circuit 600 contains a cortical column emulation circuit embodied as an IRON which computes and provides an element of state vector \vec{X}(t). Thus, the cortical column emulation circuit (not shown) of PE1 610 computes element X₁(t); the cortical column emulation circuit, IRON 2 620, of PE2 650 computes element X₂(t); the cortical column emulation circuit (not shown) of PE3 630 computes element X₃(t). X₁(t), X₂(t), and X₃(t) together form state vector \vec{X}(t). In an exemplary embodiment, X₂(t) is a local state element of state vector \vec{X}(t) corresponding to the local cortical column emulation circuit (IRON2 620), the local coupler circuit (Coupler2 640), and the local processing element (PE2 650). X₁(t) and X₃(t) form a plurality of external state elements of state vector \vec{X}(t) corresponding to a plurality of external cortical column emulation circuits (not shown), a plurality of external coupler circuits (not shown), and the plurality of external processing elements (PE1 610) and (PE3 630).

Each element of \vec{X}^{S}(t) corresponds to a sensory input of a unique processing element. X₂^{S}(t) is the second element of a dynamic feature vector, or sensory input vector \vec{X}^{S}(t), and is a sensory input to PE2 650. Although not shown, it is to be understood that X₁^{S}(t) (not shown) corresponds to a sensory input to PE1 610 and X₃^{S}(t) (not shown) corresponds to a sensory input to PE3 630. X₁^{S}(t), X₂^{S}(t), and X₃^{S}(t) together form the elements of sensory input vector \vec{X}^{S}(t). In an exemplary embodiment, X₂^{S}(t) is a local sensory element of sensory input vector \vec{X}(t) corresponding to the local cortical column emulation circuit (IRON2 620), the local coupler circuit (Coupler2 640), and the local processing element (PE2 650). X₁^{S}(t) and X₃^{S}(t) form a plurality of external sensory elements of sensory input vector \vec{X}^{S}(t) corresponding to a plurality of external cortical column emulation circuits (not shown), a plurality of external coupler circuits (not shown), and the plurality of external processing elements (PE1 610) and (PE3 630).

As set forth above with reference to FIGS. 1A and 1B, a relaxation potential controls the mapping operation performed by the IRON. In FIG. 6, IRON2 620 receives rest potential Rp2 and bifurcation parameter U₂ to generate a relaxation potential (not shown in FIG. 6). Though not shown, PE1 610 and PE2 630 also accept rest potential waveforms and bifurcation parameters to control the mappings computed by the IRONs contained within PE1 610 and PE3 630.

A coupler circuit computes the bifurcation parameter that is applied to the cortical column emulation circuit. An exemplary embodiment of a coupler circuit is Coupler2 640, which accepts a plurality of coupling factors: cross-coupling factors C₂₁ and C₂₃, self-coupling factor C₂₂, and sensory-coupling factor C^{S}₂. Coupler2 640 computes bifurcation factor U₂ using the plurality of coupling factors, sensory input vector \vec{X}^{S}(t), and a plurality of state elements of state vector \vec{X}(t). In an exemplary embodiment, Coupler2 640 of PE2 650 computes U₂ according to the equation (7):

$${U}_{2} ( t ) = A [ {{ⅇ}^{- α t} ( {X}_{2}^{S} ( t ) )}^{{C}_{2}^{S}} + \frac{( 1 - {ⅇ}^{- α t} )}{{N}_{2}} {\sum }_{j ∈ {N}_{2}} {( {X}_{j} ( t ) )}^{{C}_{2 j}} ] \qquad ( 7 )$$

where:

t is the independent variable for time, either discrete or continuous;

X^{S}₂(t) is the sensory input to coupler2 640 at time t;

C^{S}₂ is the sensory coupling factor, which in an exemplary embodiment falls within [0.1,1];

α is a weighting constant used to set the rate of decay of e^{-αt};

N₂ is the number of external processing elements connected to PE2 650 plus one;

Xⱼ(t) is a j-th element of the state vector \vec{X}(t), which Xⱼ is computed by a j-th IRON;

C₂ⱼ is a cross coupling factor corresponding to cross coupling between Xⱼ and X₂; and

A is a constant that sets the bifurcation parameter in a suitable range for the cortical column emulation circuit to exhibit complex behavior. A equals 4 for the logistic map, equals 1 for the tent map and can be suitably chosen for the sine-circle map.

IRON2 620 is cross-connected to PE1 610 and PE3 630 and self-connected to IRON2 620. Therefore, in equation (7), j ranges from 1 to 3 and N₂ is equal to 3. As can be seen from equation (7), both the various coupling factors and e^{-αt}, which varies over time and depends upon the selection of α, determine the relative influence of \vec{X}(t) and X^{S}₂(t) in the final computation of U₂.

In an exemplary embodiment, the first term, e^{-αt}(X^{S}₂(t))^{C}^{^{S}}², of equation (7) is a weighted local sensory element of a weighted sensory input vector. The second term,

$$\frac{( 1 - {ⅇ}^{- α t} )}{{N}_{2}} {\sum }_{j ∈ {N}_{2}} {( {X}_{j} ( t ) )}^{{C}_{2 j}} ,$$

of equation (7) is a plurality of weighted state element of a weighted state vector. The weighted state vector is composed of a weighted local state element

$$\frac{( 1 - {ⅇ}^{- α t} )}{{N}_{2}} {( {X}_{2} ( t ) )}^{{C}_{22}}$$

and a plurality of weighted external state elements

$$\frac{( 1 - {ⅇ}^{- α t} )}{{N}_{2}} {( {X}_{1} ( t ) )}^{{C}_{21}} and \frac{( 1 - {ⅇ}^{- α t} )}{{N}_{2}} {( {X}_{3} ( t ) )}^{{C}_{23}} .$$

Note that C₂₂ is a self-coupling factor and C₂₁ and C₂₃ are cross-coupling factors. At an early time, corresponding to a low value of t, X^{S}₂(t) is given more influence than \vec{X}(t) in the computation of U₂ because of e^{-αt}. At a later time, corresponding to a higher value of t, \vec{X}(t) is given more influence than X^{S}₂ (t) in the computation of U₂ because of (1−e^{-αt}). Thus, Coupler2 640 decreases, over time, the effect of local sensory element X^{S}₂(t) on the final calculation of bifurcation parameter U₂ and increases, over time, the effect of state vector \vec{X}(t) on the final calculation of bifurcation parameter U₂.

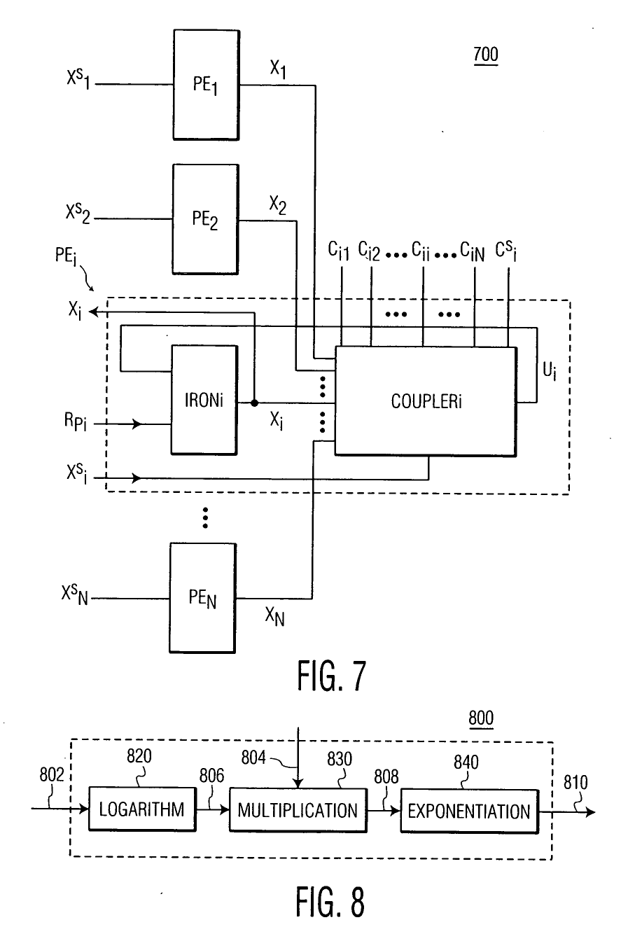

FIG. 7 shows a cortical region emulation circuit 700 in an exemplary embodiment of the present invention. Cortical region emulation circuit 700 extrapolates the cortical region emulation circuit 600 of FIG. 6 to N processing elements, each of which is connected to an i-th processing element (“PEᵢ”). The focus of the discussion of FIG. 7 is PEᵢ which operates similar to PE2 650 of cortical region emulation circuit 600.

Each of the processing elements of cortical region emulation circuit 700 receives as an input an element of sensory input vector \vec{X}^{S}(t). Thus, PE₁ receives Xᵢ^{S}(t); PE₂ receives X₂^{S}(t); PEᵢ receives Xᵢ^{S}(t); and PE_{N} receives X₁^{S}(t). X₂^{S}(t), . . . , Xᵢ^{S}(t), . . . , X_{N}^{S}(t) form the elements of sensory input vector \vec{X}^{S}(t). In an exemplary embodiment, Xᵢ^{S}(t) is a local sensory element of sensory input vector \vec{X}^{S}(t) corresponding to PEᵢ. X₁^{S}(t), . . . , Xᵢ₋₁^{S}(t), Xᵢ₊₁^{S}(t), . . . , X_{N}^{S}(t) form a plurality of external sensory elements of sensory input vector \vec{X}^{S}(t) corresponding respectively to PE₁, . . . , PEᵢ₋₁, PEᵢ₊₁, . . . , PE_{N}.

Each of the processing elements, or more specifically the cortical column emulation circuits of each processing element, of cortical region emulation circuit 700 outputs an element of state vector \vec{X}(t). Thus, IRON₁ (not shown) of PE₁ computes element X₁(t); IRON₂ (not shown) of PE₂ computes element X₂ (t); IRONᵢ computes Xᵢ(t); and IRON_{N} of PE_{N} computes X_{N}(t). X₁(t), X₂(t), . . . , Xᵢ(t), . . . , X_{N}(t) form the elements of state vector \vec{X}(t). In an exemplary embodiment, Xᵢ(t) is a local state element of state vector \vec{X}(t) corresponding to PEᵢ. X₁(t), . . . , Xᵢ₋₁(t), Xᵢ₊₁(t), . . . , X_{N}(t) form a plurality of external state elements of state vector \vec{X}(t) corresponding to PE₁, . . . , PEᵢ₋₁, PEᵢ₊₁, . . . , PE_{N}.

A relaxation potential controls the mapping performed by IRONᵢ which receives rest potential Rpᵢ and bifurcation factor Uᵢ to generate a relaxation potential (not shown) within IRONᵢ. Though not shown, PE₁, . . . , PEᵢ₋₁, PEᵢ₊₁, . . . , PE_{N} also receive relaxation potentials which control the mappings computed by the IRONs within the processing elements.

Couplerᵢ accepts a plurality of coupling factors, cross-coupling factors Cᵢ₁, Cᵢ₂, . . . , C_{iN} (excluding Cᵢᵢ), self-coupling factor Cᵢᵢ, and sensory-coupling factor C^{S}ᵢ, and uses these coupling factors, a plurality of state elements of state vector \vec{X}(t), and an i-th element X^{S}ᵢ of the sensory input vector \vec{X}^{S}(t) to compute the bifurcation parameter Uᵢ, which is used by IRONᵢ to form the relaxation potential. In an exemplary embodiment, Couplerᵢ of PEᵢ computes Uᵢ according to equation (8), which is a more general form of equation (7):

$${U}_{i} ( t ) = A [ {{ⅇ}^{- α t} ( {X}_{i}^{S} ( t ) )}^{{C}_{i}^{S}} + \frac{( 1 - {ⅇ}^{- α t} )}{{N}_{i}} {\sum }_{j ∈ {N}_{i}}^{} {( {X}_{j} ( t ) )}^{{C}_{ij}} ] \qquad ( 8 )$$

where:

i designates an index of the i-th cortical column emulation circuit IRONᵢ which is contained within PEᵢ in a set including PE₁, . . . , PE_{N};

j designates an index of a j-th cortical column emulation circuit IRONⱼ which is contained within PEⱼ in the set including PE₁, . . . , PE_{N};

t is time;

X^{S}ᵢ(t) is the local sensory element of PEᵢ at time t;

Xⱼ(t) is a j-th element of the state vector at time t corresponding to PEⱼ in the set including PE₁, . . . , PE_{N};

C^{S}ᵢ is the sensory-coupling factor of PEᵢ, which in an exemplary embodiment falls within [0.1,1]r;

Cᵢⱼ is the self-coupling factor of PEᵢ for which J=i;

Cᵢⱼ is the cross-coupling factor of PEᵢ for i≠j;

Nᵢ is the size of the set including PE₁, . . . , PE_{N};

α is a weighting used to set the rate of decay of e^{-αt};

Uᵢ is the bifurcation parameter Uᵢ of the i-th cortical column emulation circuit; and

A is a constant that has the same meaning as in equation (7).

PEᵢ is cross-coupled to PE₁, . . . , PEᵢ₋₁, PEᵢ₊₁, . . . , PE_{N}, self-coupled to PEᵢ, and sensory-coupled to X^{S}ᵢ(t). Therefore, in equation (8), j ranges from 1 to N and Nᵢ is equal to N, the total number of processing elements in cortical region emulation circuit 700. In an exemplary nearest neighbor coupling, PEᵢ is cross-coupled to PEᵢ₋₁ and PEᵢ₊₁ as well as being self coupled to PEᵢ i (i.e. being coupled to itself). As can be seen from equation (8), both the various coupling factors and e^{-αt}, which varies over time and depends upon the selection of α, determine the relative influence of \vec{X}(t) and X^{S}ᵢ(t) in the final computation of Uᵢ.

The first term, e^{-αt}(X^{S}ᵢ(t))^{C}^{^{S}}ⁱ, of equation (8) computes a weighted local sensory element of a weighted sensory input vector. The other processing elements compute the various other weighted external sensory elements of the weighted sensory input vector. The second term,

$$\frac{( 1 - {ⅇ}^{- α t} )}{{N}_{i}} {\sum }_{j ∈ {N}_{i}} {( {X}_{j} ( t ) )}^{{C}_{ij}} ,$$

of equation (8) computes a plurality of weighted state element of a weighted state vector. The weighted state vector is composed of a weighted local state element

$$\frac{( 1 - {ⅇ}^{- α t} )}{{N}_{i}} {( {X}_{i} ( t ) )}^{{C}_{ii}}$$

and a plurality of weighted external state elements

$$\frac{( 1 - {ⅇ}^{- α t} )}{{N}_{i}} {\sum }_{j ∈ {N}_{i} , j \neq i} {( {X}_{j} ( t ) )}^{{C}_{ij}} .$$

Note that Cᵢᵢ is a self-coupling factor and the Cᵢⱼ for i≠j are cross-coupling factors. At an early time, corresponding to a low value of t, X^{S}ᵢ(t) is given more influence than \vec{X}(t) in the computation of Uᵢ(t) because of e^{-αt}. At a later time, corresponding to a higher value of t, \vec{X}(t) is given more influence than X^{S}ᵢ(t) in the computation of Uᵢ(t) because of (1−e^{-αt}). Thus, Couplerᵢ decreases over time an effect of local sensory element X^{S}ᵢ(t) on the final calculation of bifurcation parameter Uᵢ(t) and increases over time an effect of state vector \vec{X}(t) on the final calculation of bifurcation parameter Uᵢ(t).

In an exemplary embodiment, the cross coupling factors are calculated according to equations (9) and (10):
Cᵢⱼ(t+1)=Cᵢⱼ(t)(1+δ tan hβIᵢⱼ(t)) (9)
Iᵢⱼ=Hᵢ+Hⱼ−2Hᵢⱼ (10)
where:

Iᵢⱼ is the normalized mutual information between the orbit of the j-th and the i-th map (as used herein, the “orbit” of a map is the sequence of values provided by the cortical column emulation circuit in response to its current stimulus);

Hᵢ and Hⱼ are their normalized entropies;

Hᵢⱼ is the normalized cross-entropy;

δ and β are constants that control the rate of adaptation occurring over a desired number of iterations of the corticonic network; and

t is time, discrete or continuous.

The entropies and cross entropies are calculated according to equations (11), (12) and (13).

$$\begin{matrix}{H}_{i} = - \frac{1}{log {N}_{b}} {\sum }_{k = 1}^{{}^{N} b} {p}_{k}^{( i )} log {p}_{k}^{( i )} & ( 11 ) \\ {H}_{j} = - \frac{1}{log {N}_{b}} {\sum }_{k = 1}^{{}^{N} b} {p}_{k}^{( j )} log {p}_{k}^{( j )} & ( 12 ) \\ {H}_{ij} = - \frac{1}{2 log {N}_{b}} {\sum }_{k = 1}^{{}^{N} b} {\sum }_{ℓ = 1}^{{}^{N} b} {p}_{k ℓ}^{( ij )} log {p}_{k ℓ}^{( ij )} & ( 13 )\end{matrix}$$

To estimate the probability pₖ⁽ⁱ⁾, the entire range [0,1] of the state variable Xᵢ(n) is divided into N_{b} equal intervals or bins. The probability pₖ⁽ⁱ⁾ is then estimated based on the relative frequency of the state variable visiting the k-th interval during the last Tₜₖ time steps and the probability pₖ^{(j)} is estimated in the same way. The probability pₖₗ^{(ij)} can be estimated in the same manner except for the natural extension to the 2-dimensional state space partitioned into N_{b}×N_{b} bins. The determination of entropies and the MI driven adaptation are commenced after a brief interval of nₜᵣ iterations following the application of a stimulus. The stimulus is applied to exclude transients. The mutual information function Iᵢⱼ is an information theoretic measure of the degree with which the orbit Xᵢ(n) of the i-th PE is influenced by the orbit, Xⱼ(n), of the j-th PE. In an exemplary embodiment, self connections and connections to the nearest neighbors (i.e. j=i, j=i−1 and j=i+1) are employed. Nearest neighbor connections avoid the global or semi-global connectivity usually encountered in conventional neural network architectures. This facilitates the hardware realization of a cortical region of cortical column emulation circuits.

As should be appreciated, each element of \vec{X}(t) might change over time. Depending upon the characteristic of a sequence of any Xᵢ(t), one can assign entropies to the Xᵢ(t). Thus, one might assign a low entropy to an ordered sequence characterized by a small change in its values. One might assign a high entropy to an ordered sequence that is chaotic and exhibits no frequently repeating set of values. One might assign a middle-level of entropy to a sequence characterized by a large set of values that repeats with some regularity.

FIG. 8 illustrates the block diagram of an adaptation circuit 800. Adaptation circuit 800 receives a first input signal 802 and a second input signal 804 and generates an output signal 810. Logarithm circuit 820 computes the natural logarithm of first input signal 802. The natural logarithm of first input signal 802 is depicted by natural logarithm 806. Multiplication circuit 830 multiplies natural logarithm 806 by second input signal 804 to generate internal signal 808. Exponentiation circuit 840 computes the exponent of internal signal 808 to generate output signal 810. Thus, the mathematical computation performed by adaptation circuit 800 is described by equation (14):
g(X,c)=(X)^{c}=exp(c×ln(X)) (14)
where X is first input signal 802, c is second input signal 804, and g(X,c)=(X)^{c} is the output signal 810. The function g(X,c) is a nonlinear activity (state) dependent coupling function.

Adaptation circuit 800 is used by a bifurcation circuit in an i-th coupler circuit for computing a bifurcation parameter Uᵢ. The bifurcation circuit may include several adaptation circuits: a sensory adaptation circuit and a plurality of state adaptation circuits, including a local state adaptation circuit and a plurality of external state adaptation circuits.

The sensory adaptation circuit of the i-th coupler receives as its first input signal a local sensory element corresponding to the i-th element of a sensory input vector \vec{X}^{S}(t) received by the i-th coupler; receives as its second input signal a sensory-coupling factor corresponding to coupling between the i-th coupler and the i-th element of sensory input vector \vec{X}^{S}(t); and computes as the output signal a weighted local sensory element.

Each respective state adaptation circuit in the i-th coupler receives as its first input signal a state element selected from a plurality of state elements which make up state vector \vec{X}(t); receives as its second input signal a respective coupling factor corresponding to the coupling between the i-th coupler and the element of state vector \vec{X}(t); and computes as the output signal a weighted state element.

The local state adaptation circuit of the i-th coupler receives as its first input signal a local state element corresponding to the i-th element of state vector \vec{X}(t) received by the i-th coupler; receives as its second input signal a self-coupling factor corresponding to the coupling between the i-th coupler and the i-th element of state vector \vec{X}(t); and computes as the output signal a weighted local state element. The other adaptation circuits produce the weighted external state elements.

It is noted that, for the exemplary local processing element coupled to two external processing elements shown in FIG. 6, the plurality of state adaptation circuits of the bifurcation circuit of the coupler circuit of the local processing element consist of a sensory adaptation circuit, a local state adaptation circuit, and two external state adaptation circuits.

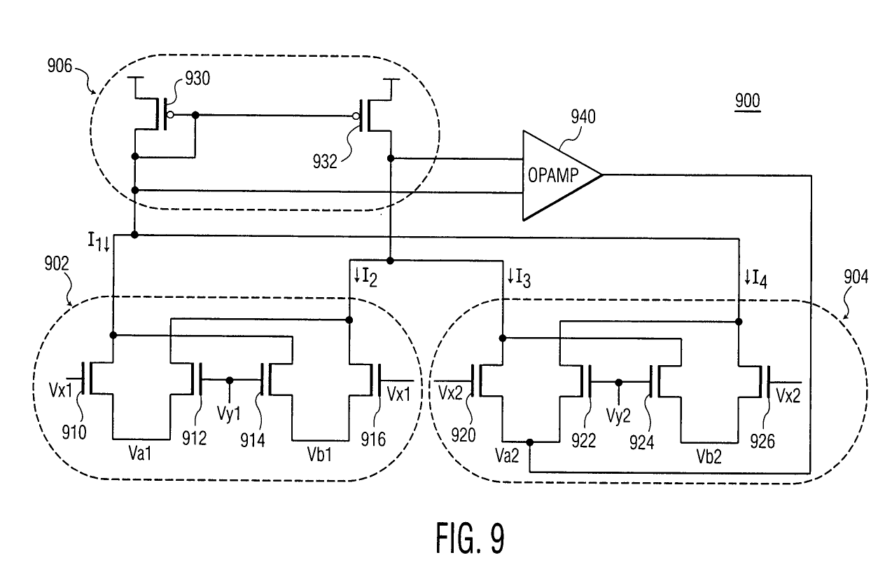

FIG. 9 illustrates an analog multiplier 900 which may be used to implement multiplication circuit 830 in FIG. 8 as well as the multiplier 158 shown in FIG. 1B. The multiplication is performed between two input signals: a first differential input voltage signal and a second differential input voltage signal. The first differential input voltage signal is defined by a difference between voltages Vₓ₁ and Vₓ₂. The second differential input voltage signal is defined by a difference between the voltages V_{y1} and V_{y2}. To accomplish the desired multiplication, analog multiplier 900 contains two CMOS Gilbert cells 902 and 904, current mirror 906, and operational amplifier 940.

A transfer function of Gilbert cell 902 is described by equations (15) and (16):
I₀=I₁−I₂=K(Vₓ₁−V_{y1})(Vₐ₁−V_{b1}) (15)

$$K = μ {C}_{ox} ( \frac{W}{L} ) \qquad ( 16 )$$

where Cₒₓ is the gate capacitance per unit area, μ is the carrier mobility (note that this symbol is different from the bifurcation parameter “μ” used in equation (3)), W is the width of the gate, and L is the length of the gate for each CMOS capacitor 910, 912, 914, and 916. CMOS transistors 910, 912, 914, and 916 are designed so that they all have substantially equal K. Thus, the various parameters of equation (16) are selected to accomplish this desirable result. The values of the parameters in equation (16) vary for different silicon processes and power dissipation requirements. In the exemplary embodiment of the invention, various Gilbert cells are used. Typical values for W and L are W=12 nm and L=6 nm. These values are selected to improve matching among transistors.

A transfer function of Gilbert cell 904 is described by equation (17):
I_{0′}=I₃−I₄=K(Vₓ₂−V_{y2})(Vₐ₂−V_{b2}) (17)
where K is described by equation (16). CMOS transistors 920, 922, 924, and 926 are designed so that they all have substantially equal K as with the CMOS transistors of Gilbert cell 902. Thus, the various parameters of equation (16) are selected to accomplish this desirable result.

Current mirror 906, which is formed by two CMOS transistors 930 and 932, supplies I₁ and I₂ to Gilbert cell 902 and I₃ and I₄ to Gilbert cell 904. Current mirror 906 and Gilbert cells 902 and 904 are designed so that I₀=I_{0′}. Thus, the transfer function of analog multiplier 900 is described by equation (18):
(Vₓ₁−V_{y1})(Vₐ₁−V_{b1})=(Vₓ₂−V_{y2})(Vₐ₂−V_{b2}) (18)
The various bias voltages Vₓ₂, V_{y2} and V_{b2} are chosen to calculate the desired multiplication between the first differential input and the second differential input. The output signal is provided as Vₐ₂.

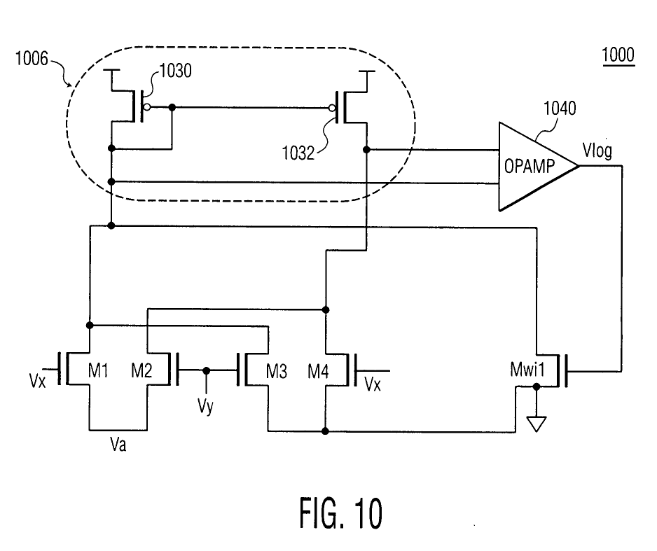

Depicted now in FIG. 10 is analog logarithmic circuit 1000 which may be used to implement logarithm circuit 820 of FIG. 8. Analog logarithmic circuit 1000 computes a logarithm of a differential input voltage signal which is characterized by the difference between voltage input signals Vₓ and V_{y}. Analog logarithmic circuit 1000 generates the logarithm of the differential input voltage signal as output voltage signal V_{log}.

Analog logarithmic circuit 1000 consists of five NMOS transistors, M₁, M₂, M₃, M₄, and M_{wi1} two PMOS transistors 1030 and 1032, and operational amplifier 1040. PMOS transistors 1030 and 1032 together form current mirror 1006. The transfer function for analog logarithm circuit 1000 is characterized by equation (19) when transistor M_{wi1} is operating in weak inversion:

$${V}_{log} - ( {V}_{TMwi 1} + {V}_{off} ) = {nv}_{t} ln ( F \frac{{( W / L )}_{1}}{{( W / L )}_{wi 1}} {V}_{a} ( {V}_{x} - {V}_{y} ) ) \qquad ( 19 )$$

(W/L)₁ is the ratio of the width to length of the gate of NMOS transistor M₁ and (W/L)_{wi1} is the ratio of the width to length of the gate of NMOS transistor M_{wi1}. Vₐ is a bias voltage that is set so that NMOS transistors M₁ and M₂ operate in the weak inversion region. V_{TMwi1} is the threshold voltage of transistor M_{wi1}; V_{off} is the offset voltage that determines the channel current at V_{gs}=0 for transistor M_{wi1}; νₜ is the thermal voltage, n is a sub-threshold switching parameter; and F is a process dependent constant,

$$F = \frac{{C}_{OX}}{{v}_{t}} \sqrt{\frac{q {ɛ}_{si} {N}_{ch}}{2 {ϕ}_{s}}} .$$

Where C_{OX} is the gate oxide capacitance per unit area, q is the electron charge, εₛᵢ is the permittivity of silicon, N_{ch} is the base doping concentration and φₛ is the work function of silicon.

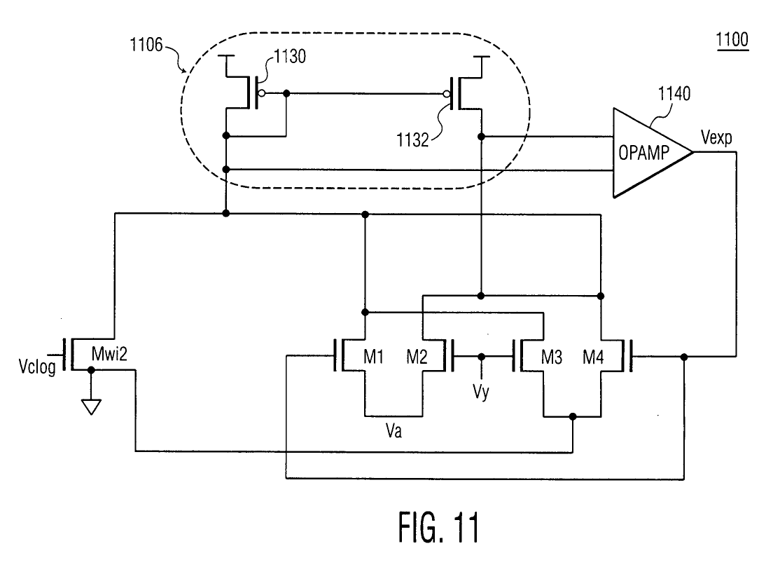

Shown next in FIG. 11 is analog exponentiation circuit 1100 which may be used to implement exponential circuit 840 of FIG. 8. Analog exponentiation circuit 1100 computes an exponent of an input voltage signal V_{clog} and outputs the result as output voltage signal Vₑₓₚ.

Analog exponentiation circuit 1100 consists of five NMOS transistors, M₁, M₂, M₃, M₄, and M_{wi2}, two PMOS transistors 1130 and 1132, and operational amplifier 1140. PMOS transistors 1130 and 1132 together form current mirror 1106. The transfer function for analog exponentiation circuit 1100 is characterized by equation (20) when M_{wi2} is operating in weak inversion:

$${V}_{exp x} - {V}_{exp y} = \frac{1}{F} \frac{{( W / L )}_{wi 2}}{{( W / L )}_{1}} \frac{1}{{V}_{a}} exp ( \frac{{V}_{c log} - ( {V}_{TMwi 2} + {V}_{off} )}{η {v}_{t}} ) \qquad ( 20 )$$

(W/L)₁ is the ratio of the width to length of the gate of NMOS transistor M₁ and (W/L)_{wi2} is the ratio of the width to length of the gate of NMOS transistor M_{wi2}. Vₐ is a bias voltage that is set so that NMOS transistors M₁ and M₂ operate in the weak inversion region. V_{y} is V_{expy}, a fixed bias voltage; V_{TMwi2} is the threshold voltage of M_{wi2}; and V_{off}i, F n and νₜ are the same as described above.

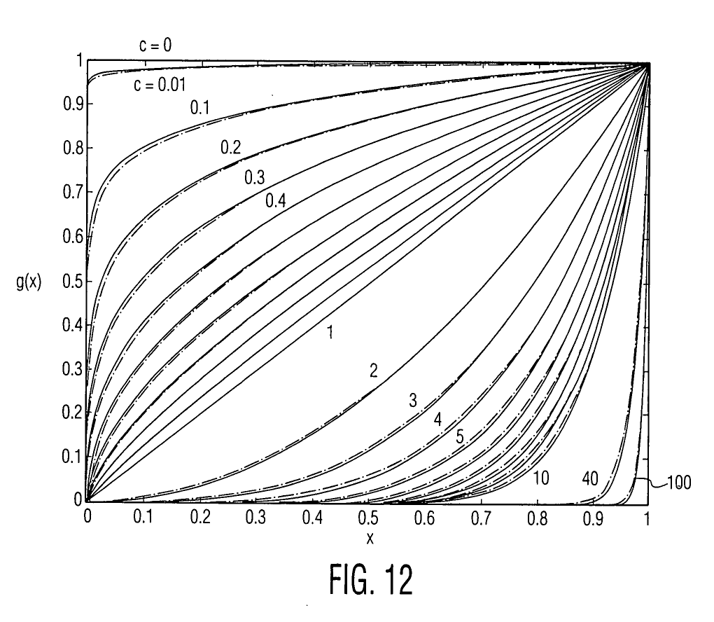

FIG. 12 depicts the actual transfer function of adaptation circuit 800 and the mathematical computation of equation (8). For purposes of FIG. 12, the various values of x are used for X in equation (8) and for first input signal 802 in adaptation circuit 800 and the various values of c are used for c in equation (8) and for second input signal 804 in adaptation circuit 800. Output signal 810 is plotted in FIG. 12 as a solid line and g(X,c) of equation (8) is plotted as a dashed line. The actual computation performed by adaptation circuit 800 closely follows the calculated values derived from equation (8). Thus, adaptation circuit 800 is an exemplary circuit for computing equation (8).

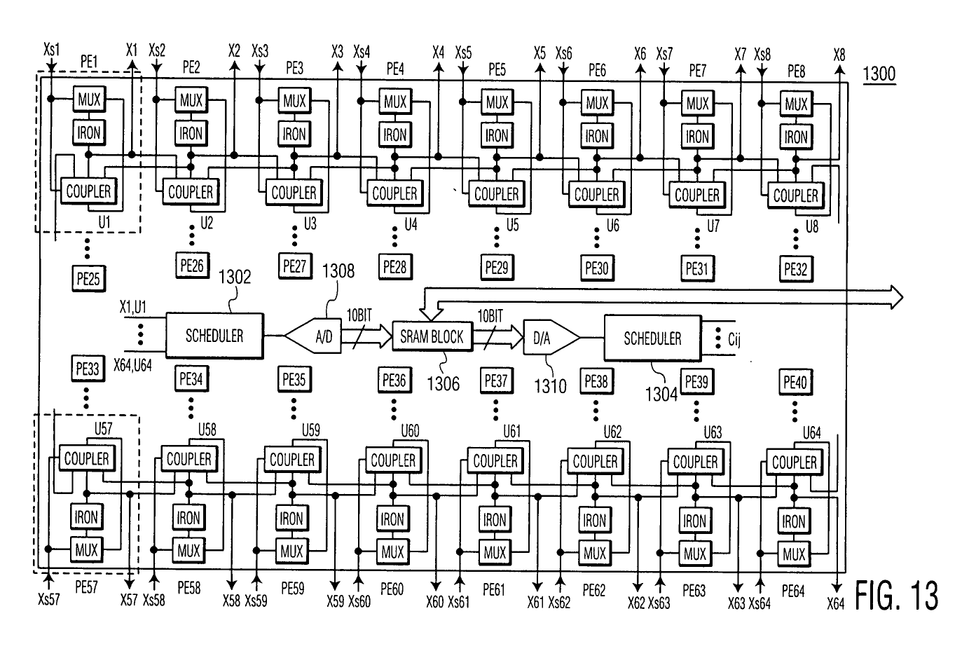

FIG. 13 discloses a cortical region emulation circuit 1300 which models a region of the cerebral cortex. The collection of the various sensory input elements XS1, XS2, . . . , XS64 form the sensory input vector \vec{X}^{S}(t); the collection of the various state elements X1, X2, . . . , X64 form the state vector \vec{X}(t); and the collection of the various bifurcation parameters U₁, U₂, . . . , U₆₄ form the vector of bifurcation parameters \vec{U}(t). Cortical region emulation circuit 1300 is composed of a set of processing elements comprising 64 processing elements, PE1, PE2, . . . , PE64. Each processing element accepts an element of the sensory input vector \vec{X}^{S}(t) and calculates and modifies an element of the state vector \vec{X}(t). For example, PE1 accepts sensory input element X₁^{S}(t) at time t of sensory input vector \vec{X}^{S}(t) and determines the value X₁(t) for time t+1.

Scheduler 1302 accepts the state vector \vec{X}(t) and the vector of bifurcation parameters \vec{U}(t), and A/D converter 1308 converts the state vector \vec{X}(t) to a digital state vector and converts the vector of bifurcation parameters \vec{U}(t) to a vector of digital bifurcation parameters. Scheduler 1302 serves to send A/D converter 1308 the elements of state vector \vec{X}(t) and the element of the vector of bifurcation parameters \vec{U}(t) one at a time, so that A/D converter 1308 may convert each analog element to a digital element one at a time for storage in SRAM block 1306, which in an exemplary embodiment is a random-access memory. In an exemplary embodiment, A/D converter 1308 converts its analog input signal to a 10-bit digital output signal.

A digital computer (not shown) computes a vector of digital coupling factors responsive to the vector of digital bifurcation parameters and the digital state vector. One algorithm a computer might use to compute the vector of digital coupling factors is described by equations (9) and (10) above. The digital computer may assign values to the entropies in equation (10) according to the entropies of the digital state vector and the vector of digital bifurcation parameters, assigning low entropies to sequences of values of the elements that are regular (i.e. fixed or slightly changing) and high entropies to irregular sequences of values of the elements that change randomly or periodically over long periods. The computer may also assign values to the mutual information, based, for example, on a correlation between the orbits of respective ones of the state variables.

After the digital computer computes the vector of digital coupling factors, the digital computer stores the vector of digital coupling factors in SRAM block 1306. D/A converter 1310 converts the vector of digital coupling factors to a vector of coupling factors, which is an analog signal and is comprised of two vectors: a vector of sensory coupling factors and a vector of state coupling factors. The i-th element of the vector of sensory coupling factors corresponds to the coupling of the i-th processing element to an i-th element of sensory input vector \vec{X}_{S}(t). The two-dimensional vector of state coupling factors describes the coupling between the i-th element of state vector \vec{X}(t) and a j-th element of state vector \vec{X}(t). It is noted that in an exemplary embodiment D/A converter 1310 converts its 10-bit digital input to an analog output

Each processing element in cortical region emulation circuit 1300, in addition to its self-coupling, is coupled to a subset of processing elements by its coupler circuit. For example, PE1 is coupled to PE2 and PE9 (not shown) if cyclic boundary conditions are adopted and to PE2 only (in which case Nᵢ=2) when non-cyclic boundary conditions are adopted; PE2 is coupled to PE1 and PE3; PE25 is coupled to PE17 (not shown) and PE26; etc. More specifically, the coupler circuit in each of the processing element is coupled to the IRON circuits of the processing elements to which the coupler circuit is coupled. Thus, the coupler circuit of PE1 is coupled to the output terminal of the IRON of PE2 and to the output terminal of the IRON of PE9 (not shown); the coupler circuit of PE2 is coupled to the output terminal of the IRON of PE1 and to the output terminal of the IRON of PE3; the coupler circuit of PE25 is coupled to the output terminal of the IRON of PE17 (not shown) and to the output terminal of the IRON (not shown) of PE26; etc.

Each processing element depicted in FIG. 13 is coupled to other processing elements in a nearest-neighbor configuration. In a nearest-neighbor configuration a local cortical column emulation circuit (IRON) of a local processing element is coupled to a plurality of external cortical column emulation circuits of a plurality of external processing elements that are near or adjacent to the local cortical column emulation circuit. For example, if PE2 is the local processing element and PE1 and PE3 form the plurality of external processing elements, the connection of the IRON (local cortical column emulation circuit) of PE2 to the IRONs (plurality of external cortical column emulation circuits) of PE1 and PE3 is a nearest-neighbor connection.

In a random global, non-local configuration a local cortical column emulation circuit of a local processing element may be randomly coupled to a plurality of external cortical column emulation circuits. For example, if PE2 may also be connected to PE15 and/or PE54, the connection scheme is a random global, non-local configuration.

Cortical region emulation circuit 1300 accepts sensory input vector \vec{X}^{S}(t), which may be either a static or dynamic input signal, and computes state vector \vec{X}(t). Each of the processing elements of cortical region emulation circuit 1300 modifies a respective element of the state vector \vec{X}(t) responsive a respective element of the vector of bifurcation parameters \vec{U}(t) and a respective rest potential signal. Each coupler of each processing element computes a respective element in the vector of bifurcation parameters \vec{U}(t) responsive to a respective element of the sensory input vector \vec{X}^{S}(t) modified by an element of the vector of sensory coupling factors \vec{C}^{S} and to a plurality of respective elements of the state vector \vec{X}(t) modified by the vector of state coupling factors. In an exemplary embodiment, each coupler of cortical region emulation circuit computes respective element of the vector of bifurcation parameters \vec{U}(t) according to equation (8).

As is also depicted in FIG. 13, each processing element contains a multiplexer denoted by MUX. In an exemplary embodiment, each MUX of each processing element controls whether the IRON to which it is coupled receives either a respective element of the vector of bifurcation parameters \vec{U}(t) or a respective one of the various sensory input elements. At an earlier time, the MUX passes the respective one of the various sensory input elements while blocking the respective element of the vector of bifurcation parameters \vec{U}(t) to the respective IRON. At a later time, the MUX passes the respective element of the vector of bifurcation parameters \vec{U}(t) to the respective IRON while blocking the respective one of the various sensory input elements.

The operation of the cortical region emulation circuit 1300 as a neural network is essentially the same as described in Published U.S. patent application no. 2004/0073415 A1. entitled DYNAMICAL BRAIN MODEL FOR USE IN DATA PROCESSING APPLICATIONS. In particular, a stimulus vector is applied to the processing elements of the circuit 1300 and the circuit is operated until it reaches a stable state (i.e. the output signals of the cortical column emulation circuits indicate that they are at an attractor). This step defines a coupling among the processing elements. Next, the processing elements are switched, via the multiplexers to respond to the bifurcation parameters and the circuit 1300 is again operated until it reaches a stable state. In a learning mode, this stable state is labeled and recorded in a memory. In an operational state, the memory is searched for the stable state and the corresponding label is provided as the output signal of the neural network.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A cortical column emulation circuit comprising:
(a) a capacitor having a first end and a second end, wherein the second end is coupled to a source of reference potential;
(b) a switch configured to close responsive to a control signal for selectively coupling the first end of the capacitor to a source of reference signal;
(c) a current source coupled to the first end of the capacitor for charging the capacitor when the switch is open to develop a capacitor voltage between the first end and the second end of the capacitor;
(d) a comparator coupled to the first end of the capacitor and to a threshold voltage, the comparator being configured to generate an output signal at an output terminal of the comparator, wherein the output signal of the comparator provides:
(i) a first comparator state signal value that corresponds to a first relationship between the capacitor voltage and the threshold voltage; and
(ii) a second comparator state signal value that corresponds to a second relationship between the capacitor voltage and the threshold voltage; and
(e) a pulse generator coupled to the output terminal of the comparator:
(i) wherein the pulse generator generates a pulse signal when the output signal of the comparator transitions from the first comparator state signal value to the second comparator state signal value; and
(ii) wherein the pulse signal is the control signal for the switch.

2. The cortical column emulation circuit of claim 1 further comprising:
a terminal for applying a timing signal; and
a sample-and-hold circuit coupled to the terminal and to the pulse generator, wherein the sample-and-hold circuit samples the timing signal at instants indicated by the pulse signal to generate a sequence of output values.

3. The cortical column emulation circuit of claim 2 wherein the timing signal is a periodic signal having a period at least as great as a time for the current source to charge the capacitor voltage from a value equal to a minimum voltage of the reference signal to the threshold voltage.

4. The cortical column emulation circuit of claim 2 wherein the timing signal is a ramp signal.

5. The cortical column emulation circuit of claim 1 further comprising:
(a) a terminal for applying rest potential signal;
(b) a terminal for applying bifurcation parameter signal Uᵢ; and
(c) a multiplier which receives the rest potential signal and the bifurcation parameter signal and generates the reference signal by multiplying the rest potential signal by the bifurcation parameter signal Uᵢ.

6. The cortical column emulation circuit of claim 5 further comprising an adder which modifies the reference signal generated by the multiplier by adding an offset voltage to the reference signal.

7. An adaptation circuit comprising:
(a) a logarithm circuit which receives a first input signal and computes a logarithm of the first input signal;
(b) a multiplication circuit coupled to the logarithm circuit, wherein the multiplication circuit:
(i) receives a second input signal;
(ii) receives the logarithm of the first input signal; and
(iii) multiplies the logarithm of the first input signal by the second input signal to generate an internal signal; and
(c) an exponentiation circuit coupled to the multiplication circuit, wherein the exponentiation circuit:
(i) receives the internal signal; and
(ii) computes an exponent of the internal signal to generate an output signal.

8. A coupler circuit for coupling a local cortical column emulation circuit to a plurality of external cortical column emulation circuits, the coupler circuit comprising:
(a) a terminal for applying a sensory input signal;
(b) a plurality of terminals for applying respective state elements of a state vector;
(c) a plurality terminals for applying respective coupling factors; and
(d) a bifurcation circuit for computing the bifurcation parameter Uᵢ, the bifurcation circuit comprising:
(i) a sensory adaptation circuit in accordance with the adaptation circuit of claim 7 wherein:
(A) the sensory input signal is the first input signal of the sensory adaptation circuit;
(B) a sensory-coupling factor selected from the plurality of coupling factors is the second input signal of the sensory adaptation circuit; and
(C) the output signal of the sensory adaptation circuit is a weighted local sensory element; and
(ii) a plurality of state adaptation circuits, each respective state adaptation circuit in accordance with the adaptation circuit of claim 7, wherein, for the each respective state adaptation circuit:
(A) a respective state element selected from the plurality of state elements is the first input signal of the state adaptation circuit;
(B) a respective coupling factor selected from the plurality of coupling factors is the second input signal of the state adaptation circuit; and
(C) the output signal of the state adaptation circuit a respective weighted state element.

9. The coupler circuit of claim 8 wherein the plurality of state adaptation circuits comprises:
(a) a local state adaptation circuit wherein:
(i) a local state element selected from the plurality of state elements is the state element of the local state adaptation circuit;
(ii) a self-coupling factor selected from the plurality of coupling factors is the coupling factor of the local state adaptation circuit; and
(iii) the output signal of the local state adaptation circuit is a weighted local state element; and
(b) a plurality of external adaptation circuits, wherein, for each respective external adaptation circuit of the plurality of external adaptation circuits:
(i) an external state element selected from the plurality of state elements is the state element of the respective external adaptation circuit;
(ii) a cross-coupling factor selected from the plurality of coupling factors is the coupling factor of the respective external adaptation circuit; and
(iii) the output signal of the external adaptation circuit is a respective weighted external state element.

10. The coupler circuit of claim 8 wherein the plurality of state adaptation circuits comprises four state adaptation circuits.

11. The coupler circuit of claim 9 wherein the bifurcation circuit computes the bifurcation parameter Uᵢ(t) according to the equation:
$${U}_{i} ( t ) = A [ {{ⅇ}^{- α t} ( {X}_{i}^{S} ( t ) )}^{{C}_{i}^{S}} + \frac{( 1 - {ⅇ}^{- α t} )}{{N}_{i}} {\sum }_{j ∈ {N}_{i}} {( {X}_{j} ( t ) )}^{{C}_{ij}} ] , \\ wherein :$$
(a) i designates an index of an i-th cortical column emulation circuit in a set including the local cortical column emulation circuit and the plurality of external cortical column emulation circuits, wherein the i-th cortical column emulation circuit is the local cortical column emulation circuit;
(b) j designates an index of a j-th cortical column emulation circuit in the set including the local cortical column emulation circuit and the plurality of external cortical column emulation circuits;
(c) t is time;
(d) X^{S}ᵢ(t) is the local sensory element of the i-th cortical column emulation circuit at time t;
(e) Xⱼ(t) is a j-th element of the state vector at time t;
(f) C^{S}ᵢ is the sensory-coupling factor of the i-th cortical column emulation circuit;
(g) Cᵢᵢ is the self-coupling factor of the i-th cortical column emulation circuit for which j=i;
(h) Cᵢⱼ is the cross-coupling factor of the i-th cortical column emulation circuit for which j≠i;
(i) Nᵢ is a size of the set including the local cortical column emulation circuit and the plurality of external cortical column emulation circuits;
(j) α is a weighting factor; and
(k) A is a constant that sets the bifurcation parameter in a suitable range for the cortical column emulation circuit to exhibit complex behavior.

12. The coupler circuit of claim 8 wherein the coupler circuit couples the local cortical column emulation circuit to the plurality of external cortical column emulation circuits in a nearest-neighbor configuration.

13. The coupler circuit of claim 12 wherein the coupler circuit couples the local cortical column emulation circuit to the plurality of external cortical column emulation circuits in a random global, non-local configuration.

14. A processing element comprising:
(a) a terminal for applying a local sensory element of a sensory input vector;
(b) a terminal for applying a local state element of a state vector;
(c) a plurality of terminals for applying a respective plurality of coupling factors;
(d) a terminal for applying a rest potential waveform;
(e) a coupler circuit for coupling the processing element to a plurality of external processing elements, wherein the coupler computes a bifurcation parameter Uᵢ responsive to the local sensory element, the state vector, and the plurality of coupling factors; and
(f) a cortical column emulation circuit that modifies the local state element responsive to the bifurcation parameter and the rest potential signal, wherein the cortical column emulation circuit models a bifurcating neuron which implements a one-dimensional map determined by the rest potential signal.

15. The processing element of claim 14 wherein the coupler decreases over time an effect of the local sensory element on the bifurcation parameter Uᵢ and increases over time an effect of the state vector on the bifurcation parameter Uᵢ.

16. The processing element of claim 14 wherein the coupler circuit calculates the bifurcation parameter Uᵢ responsive to a weighted local sensory element and a weighted state vector.

17. The processing element of claim 16 wherein the coupler circuit:
(a) calculates the weighted value local sensory element responsive to the local sensory element and an inverse exponential of time; and
(b) calculates the weighted state vector responsive to the state vector and unity minus the inverse exponential of time.

18. The processing element of claim 16 wherein
(a) the plurality of coupling factors comprises:
(i) a sensory-coupling factor;
(ii) a self-coupling factor; and
(iii) a plurality of cross-coupling factors;
(b) the state vector comprises:
(i) a local state element calculated by a cortical column emulation circuit of the processing element; and
(ii) a plurality of external state elements calculated by a plurality of external cortical column emulations circuits of external processing elements;
(c) the weighted state vector comprises:
(i) a weighted local state element; and
(ii) a plurality of weighted external state elements; and
(d) the coupler circuit:
(i) calculates the weighted local sensory element responsive to the local sensory element and the sensory-coupling factor;
(ii) calculates the weighted local state element responsive to the local state element and the self-coupling factor; and
(iii) calculates the plurality of weighted external state elements responsive to the plurality of external state elements and the plurality of cross-coupling factors.

19. The processing element of claim 18 wherein the coupler circuit calculates the bifurcation parameter Uᵢ(t) according to the equation:
$${U}_{i} ( t ) = A [ {{ⅇ}^{- α t} ( {X}_{i}^{S} ( t ) )}^{{C}_{i}^{S}} + \frac{( 1 - {ⅇ}^{- α t} )}{{N}_{i}} {\sum }_{j ∈ {N}_{i}} {( {X}_{j} ( t ) )}^{{C}_{ij}} ] , \\ wherein :$$
(a) i designates an index of an i-th processing element in a set including the processing element and the plurality of external processing elements, wherein the i-th processing element is the processing element;
(b) j designates an index of a j-th processing element in the set including the processing element and the plurality of external processing elements;
(c) t is time;
(d) X^{S}ᵢ(t) is the local sensory element of the i-th processing element at time t;
(e) Xⱼ is a j-th element of the state vector at time t;
(f) C^{S}ᵢ is the sensory-coupling factor of the i-th processing element;
(g) Cᵢⱼ is the self-coupling factor of the i-th processing element for which j=i;
(h) Cᵢⱼ is the plurality of cross-coupling factors of the i-th processing element for which j≠i;
(i) Nᵢ is a size of the set including the processing element and the plurality of external processing elements;
(j) α is a weighting factor; and
(k) A is a constant that sets the bifurcation parameter in a suitable range for the cortical column emulation circuit to exhibit complex behavior.

20. The processing element of claim 16 wherein the coupler circuit comprises a multiplexer by which the coupler:
(a) at first time, computes the bifurcation parameter Uᵢ(t) from the weighted local sensory element; and
(b) at a second time after the first time, computes the bifurcation parameter Uᵢ(t) from the weighted state vector.

21. The processing element of claim 14 wherein the cortical column emulation circuit comprises:
(a) a capacitor having a first end and a second end, wherein the second end is coupled to a source of reference potential;
(b) a switch configured to close responsive to a control signal for selectively coupling the first end of the capacitor to a source of reference signal;
(c) a current source coupled to the first end of the capacitor for charging the capacitor when the switch is open to develop a capacitor voltage between the first end and the second end of the capacitor;
(d) a comparator coupled to the first end of the capacitor and to a threshold voltage, the comparator being configured to generate an output signal at an output terminal of the comparator, wherein the output signal of the comparator provides:
(i) a first comparator state signal value that corresponds to a first relationship between the capacitor voltage and the threshold voltage; and
(ii) a second comparator state signal value that corresponds to a second relationship between the capacitor voltage and the threshold voltage; and
(e) a pulse generator coupled to the output terminal of the comparator:
(i) wherein the pulse generator generates a pulse signal when the output signal of the comparator transitions from the first comparator state signal value to the second comparator state signal value; and
(ii) wherein the pulse signal is the control signal for the switch.

22. The processing element of claim 21 wherein the cortical column emulation circuit further comprises:
a terminal for applying a timing signal; and
a sample-and-hold circuit coupled to the terminal and to the pulse generator, wherein the sample-and-hold circuit samples the timing signal at instants indicated by the pulse signal to generate a sequence of output values.

23. The processing element of claim 22 wherein the timing signal is a periodic signal having a period at least as great as a time for the current source to charge the capacitor voltage from a value equal to a minimum voltage of the reference signal to the threshold voltage.

24. The processing element of claim 22 wherein the timing signal is a ramp signal.

25. The processing element of claim 21 wherein the cortical column emulation circuit further comprises:
(a) a terminal for applying a rest potential signal;
(b) a terminal for applying a bifurcation parameter signal, Uᵢ; and
(c) a multiplier which receives the rest potential signal and the bifurcation parameter signal and generates the reference signal by multiplying the rest potential signal by the bifurcation parameter signal, Uᵢ.

26. The processing element of claim 25 wherein the cortical column emulation circuit further comprises an adder which modifies the reference signal generated by the multiplier by adding an offset to the reference signal.

27. A cortical region emulation circuit comprising:
(a) a sensory input vector;
(b) a state vector;
(c) a set of processing elements for calculating respective elements of the state vector, wherein each processing element in the set of processing elements:
(i) is coupled to a subset of processing elements of the set of processing elements; and
(ii) modifies a respective element of the state vector responsive to:
(A) a respective element of the sensory input vector modified by a respective coupling factor;
(B) a plurality of respective elements of the state vector modified by a vector of state coupling factors;
(C) a rest potential signal; and
(D) a respective element of a vector of bifurcation parameters.

28. The cortical region emulation circuit of claim 27 further comprising a digital computer for updating the sensory coupling factors and the state coupling factors responsive to the state vector and the vector of bifurcation parameters.

29. The cortical region emulation circuit of claim 28 further comprising:
(a) an analog-to-digital converter for converting the state vector to a digital state vector and for converting the vector of bifurcation parameters to a vector of digital bifurcation parameters, wherein the digital computer computes a vector of digital coupling factors responsive to the digital state vector and the vector of digital bifurcation parameters; and
(b) a digital-to-analog converter for converting the vector of digital coupling factors to the vector of coupling factors for use by the set of processing elements.

30. The cortical region emulation circuit of claim 27 wherein the set of processing elements comprises 64 processing elements.

31. The cortical region emulation circuit of claim 27 further comprising a multiplexer which:
(a) at an earlier time, prevents the each processing element from modifying the respective element of the state vector responsive to the respective element of the vector of bifurcation parameters but causes the each processing element to modify the respective element of the state vector responsive to the respective element of the sensory input vector; and
(b) at a later time, prevents the each processing element from modifying the respective element of the state vector responsive to the respective element of the sensory input vector but causes the each processing element to modify the respective element of the state vector responsive to the respective element of the vector of bifurcation parameters.
